(19) United States
(12) Patent Application Publication
(10) Pub. No.: US 2002/0167228 A1
(43) Pub. Date: Nov. 14, 2002

(54) Timed safety device

(76) Inventor: Jose I. Rivera, Flowery Branch, GA (US)

Correspondence Address: WOMBLE CARLYLE SANDRIDGE & RICE, P.O. Box 7037, Atlanta, GA, 30357-0037, US

(21) Appl. No.: 09/852,203

(22) Filed: May 9, 2001

(51) Int. Cl. H02J 4/00

(52) U.S. Cl. 307/326

(57) ABSTRACT

A timed safety device is connected to the gas or electrical supply line of a kitchen appliance. The timed safety device includes a timer, a voltage transformer, and a shutoff device that is connected to the supply power line for the appliance. The shutoff device is controlled by the timer, which is powered by the voltage transformer and is set by a user to a predefined time period before turning on the appliance. When the pre-set timer period expires, the shutoff device cuts off the supply of gas or electrical power to the appliance.

### CROSS-REFERENCE

Reference is hereby made to U.S. Disclosure Document No. 466954, filed Dec. 27, 1999, which document is incorporated herein by this reference.

### FIELD OF THE INVENTION

This invention relates to the field of timing devices or systems. More particularly, this invention relates to timing devices for controlling the operation of kitchen appliances.

### BACKGROUND OF THE INVENTION

Appliances such as gas or electric stoves and other kitchen appliances are generally taken for granted as simple, common conveniences of modern life. Such common everyday use of these appliances, however, often leads people to take for granted the fact that these devices must be used with a certain degree of care and with reasonable safety precautions being taken. For example, a stove left on and unattended, creates a serious risk of fire and potential explosion for gas stoves, possibly leading to property damage and/or serious physical injury.

The potential for injury and or damage is further increased by the operation of such gas and/or electric powered appliances by children and the elderly. More and more senior citizens are enjoying independent lives, even at advanced ages. They want to maintain an active and independent lifestyle and do not want to be a burden to their children. However, as people age, they tend to become forgetful, and their safety becomes an increasing concern. Often older people leave their cooking stoves on and unattended due to forgetfulness, often with serious and possibly dire consequences. Likewise, young children sometimes will try to operate appliances such as a stove without understanding or appreciating the dangers inherent in such a device and may fail to shut off the appliance simply because they don't understand or forget to do so.

What is needed, therefore, is a safety device for use with appliances or similar devices that solves these and other problems in the art.

### SUMMARY OF THE INVENTION

Briefly described, the present invention generally discloses a timed safety device for use with an appliance such as a gas or electric cooking stove. The safety device includes a timer connected to a voltage supply and an electrically controlled shutoff device. The shutoff device functions to selectively shutoff delivery from an energy source of the energy (for example, gas or electricity) necessary to operate the appliance. The voltage supply generally can include a battery or other direct current source, and/or a voltage transformer that is connected to an electrical outlet. The voltage transformer supplies power to the timer at a relatively low voltage, for example, 12 volts, for operating the timer and for control of the shutoff device with risk of sparks being minimized.

In one embodiment of the present invention, the shutoff device typically includes a valve that is placed along a gas supply line, for a gas consuming appliance, such as a gas cooking stove.

In an alternate embodiment, the safety device is installed in communication with an electrical appliance such as an electric stove. In this embodiment, the shutoff device includes an electrical shutoff switch placed along the electricity supply line between the electrical energy source outlet and the stove, and is generally designed to handle up to at least 220 volts, although greater or lesser power levels can also be accommodated as needed, depending on the current levels used to power the electric device.

Before use, a user turns on the safety device by setting the timer. Once the timer is set, the energy (for example, gas or the electricity) will be permitted or enabled to flow from the respective energy source to the appliance device being monitored, such as a cooking stove, thus permitting normal use of the appliance. The user then proceeds with normal use of the appliance such as cooking a meal and, once finished, the user then typically will turn off the appliance. If for some reason the user does not properly turn off the appliance, the safety device will ensure that the appliance is turned off, that is, receives no energy for operation, when the time set on the timer expires. At that point, the shutoff device will automatically shutoff the gas or electricity supplied from the respective energy source to the appliance and prevent further restarting and use of the appliance until the timer of the safety device is reset.

Various features, objects and advantages of the present invention, in addition to those mentioned or implied above, will become apparent upon a reading of the following specification, when taken in conjunction with the appended drawings.

### DESCRIPTION OF DRAWINGS

The invention is better understood by reading the following detailed description of the preferred embodiment in conjunction with the accompanying drawings, wherein:

FIG. 1 is a schematic illustration of one embodiment of the present invention for use with a gas cooking stove.

FIG. 2 is a schematic illustration of another embodiment of the present invention for use with an electrical cooking stove.

FIG. 3 is a flow chart illustrating the operation of the present invention for controlling a stove.

### DETAIL DESCRIPTION

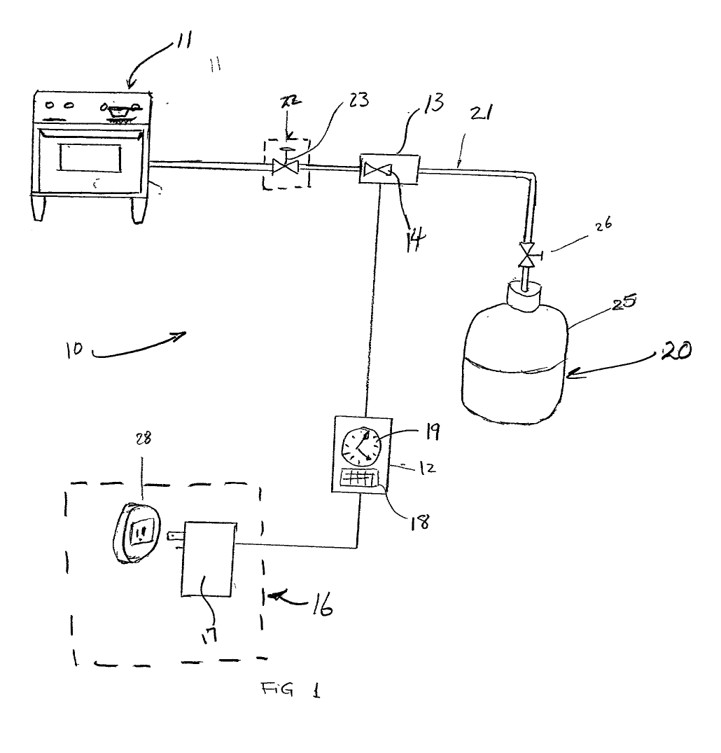

Referring now in greater detail to the drawings in which like numerals represent like components throughout the several views, the present invention is directed to a timed safety device 10 for controlling electric or gas powered appliances or device. The invention is shown and described below particularly for use with gas and electric stoves. It will, however, be understood by those skilled in the art that the present invention could have utility and applicability to a variety of electric and gas powered devices and should not be viewed as being limited solely to use with stoves or cooking devices. FIG. 1 illustrates a first embodiment of the timed safety device of the present invention used in conjunction with a gas consuming appliance 11 (depicted as a cooking stove 11) connected to an energy source 20 in the form of, for example, a source of natural gas. The timed safety device 10 generally comprises a timer 12 that is connected to a shutoff device 13, which includes a shutoff valve 14, and a power supply 16 such as a battery or electrical outlet, and generally also includes a voltage transformer 17.

The timer 12 can be a mechanically or electrically operated timer, as conventionally known, and generally will be programmable with a set or desired timer period. Typically, the programmed time(s) are selectably set by a user for predefined intervals such as, for example, 20 minutes, 30 minutes, or one hour. However, the timer 12 also typically will be designed to enable programming of a user-defined period of greater or lesser times. For example, the timer can be designed to be programmed with any desired time period or can be programmed with a limited, set time (i.e., an hour) but provided with a user override switch or programming that enables the preset times to be overridden with shorter or longer times (i.e. 1½ to 2+ hours), upon activation or entry of an override code. The timer 12 generally will have a keypad input system or mechanism 18 or a dial input system (not shown) for programming the desired time intervals, and a dial or LED readout 19 or display for displaying the programmed and elapsed times. When the selected time set by the user expires, the timer 12 activates the circuitry to close the shutoff valve 14 and to cut off the gas supply to the cooking stove 11 from the energy source 20.

The shutoff valve 14 generally is a conventional, electrically controlled coil type gas shut off valve controlled by the timer 12, although other arrangements, such as a pneumatically operated valve, can also be used. The shutoff valve 14 is placed along a gas supply line 21 between the gas energy source 20 and the manual on/off control 22 of the appliance 11 (which includes, for example, one or more manually manipulated gas flow control valves 23 for the gas cooking stove 11). The gas energy source 20 can be either a gas tank, indicated at 25, that is commercially available, or a gas pipe line supplied to residential houses and which supplies a flow of natural gas, propane or other gaseous fuel to the stove 11. When installing the shutoff valve 14, the user shuts off gas safety valve 26 adjacent the gas source, which shuts off the gas supply line 21 from the stove and prevents leakage of gas. The user then places and connects the shutoff valve 14 between two sections of the gas supply line. After the shutoff valve 14 is installed, the gas safety valve 26 is turned back on to reestablish the gas flow to the stove.

The power supply 16 for the timed safety device 10 can include a variety of sources such as a battery or a direct connection to the electric power supply of a home via a power outlet 28. Typically, a voltage transformer 17 will be provided, generally including a low voltage electrical transformer and provides power to the timer 12 and the shutoff valve 14 for the operation of the safety device. The voltage transformer 17 is generally connected to electrical power or outlet source 28, such as the 115/220-volt outlet of the home in which the stove is placed, a battery, or similar power source. The voltage transformer 17 provides a low voltage current to the timer 12 and the shutoff valve 14, with the voltage provided by the transformer typically being about 12 volts or less to minimize the risk of electrical sparks.

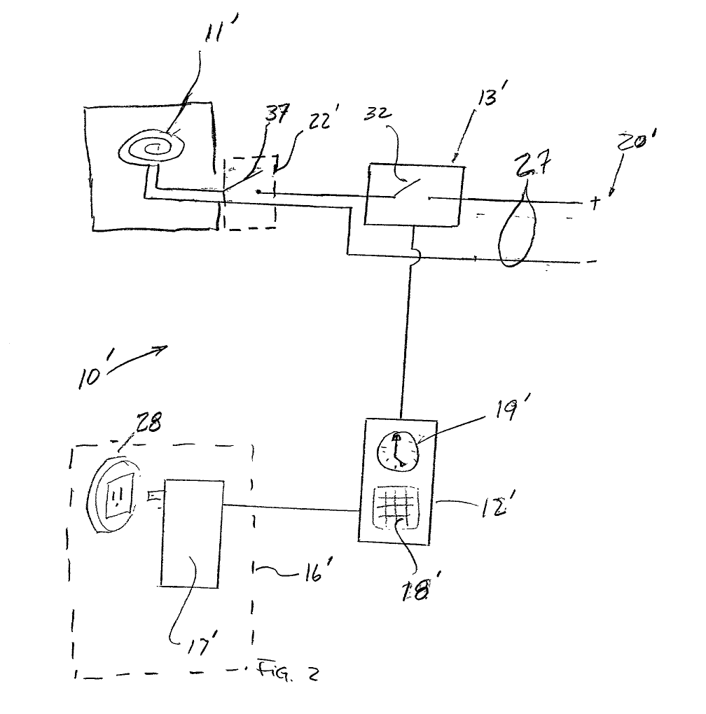

FIG. 2 illustrates a timed safety device 10′ according to the present invention, for use with an electrically powered appliance 11′ (depicted as electrically powered cooking stove 11′). The timed safety device 10′ generally comprises a shutoff device 13′ which includes a shutoff switch 32 controlled by a timer 12′, which is connected to a power supply 16′, typically including a voltage transformer 17′. The shutoff switch 32 generally is an electrically powered contact switch or electrical disconnect switch designed to handle high voltage current, generally 220 volts or more, as is needed for the electric cooking stove 11′, and is controlled by the low voltage current supplied by the voltage transformer 17′. The shutoff switch 32 can also work with electrical cooking stoves that use other voltages such as 115 volts. The shutoff switch 32 is placed along an electrical power line 27 between an energy source 20′ (in the form, for example, of a high voltage current source) and a manual on/off control 22′ of the appliance 11′ (which includes, for example, one or more manually manipulated control switches 37 for the electrical appliance 11′). The shutoff switch 32 can, for example, control one power line, if the voltage is 115 volts or additional power lines if the voltage is 220 volts.

The power supply 16′, any related voltage transformer 17′, and the timer 12′ generally will be the same as described above with reference to the embodiment of FIG. 1 and generally have the same functional characteristics. It will, however, be understood that, alternatively, the shutoff switch 32 and the timer 12′ can be integrated as the same device, such as a timer controlled switch or circuit. It is also possible to connect the timer directly to the power supply (for example, omitting the transformer 17 and outlet 28) for control and shut off of the power supplied to the stove, especially where the shutoff switch and timer are the same device. The timer 12′ will include an input device such as a keypad 18′ and a display 19′, such as a dial or LED, on which the programmed time interval is programmed and displayed. When the selected time period expires, the timer activates the circuitry to open the shutoff switch 32 and cut the supply of current to the electrical cooking stove 11′.

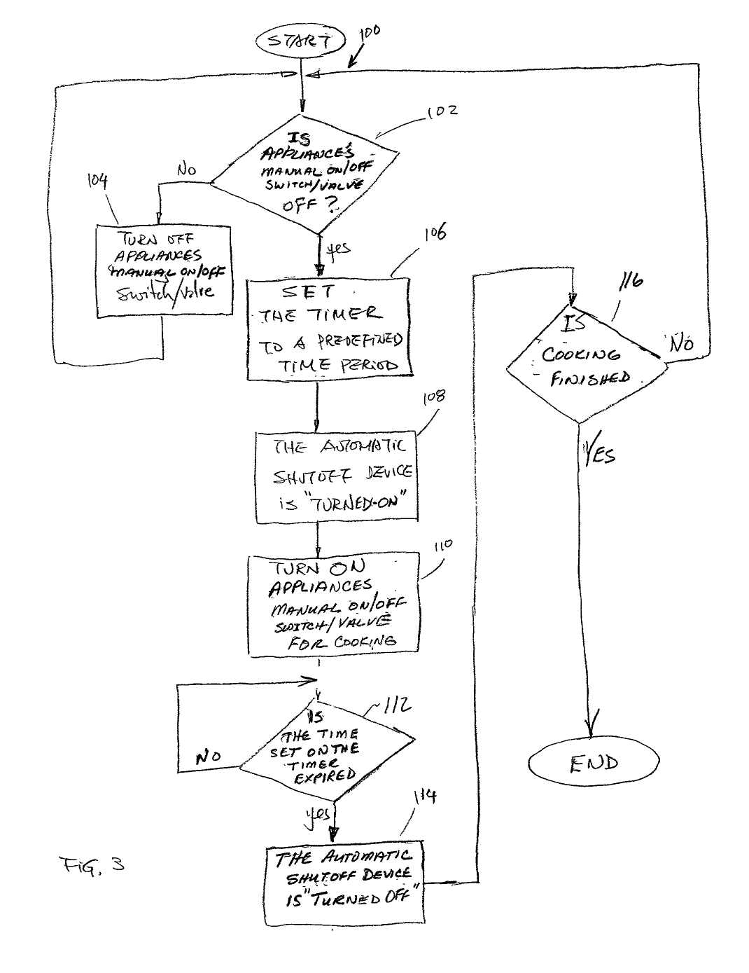

FIG. 3 is a flow chart illustrating the sequence of operation 100 for a cooking procedure using the present invention. Before starting cooking, as an initial step 102, the user makes sure that the manual on/off control(s) 22, 22′ (valve 23 or switch 37) of the cooking stove is shut off and if it is not, then the manual valve or switch is turned off as indicated in step 104. This is important to ensure that energy, i.e., gas or electricity, is not supplied to the appliance inadvertently. After this initial step 102, the user then sets the timer 12, 12′ of the shutoff device 13, 13′ in step 106 to either a predefined time period or any user defined time period, if the timer is so equipped. After the desired time period is set or programmed, the timer will activate the circuitry to place the shutoff device 13, 13′ in the “turned-on mode”, at step 108, to enable energy to be supplied to the appliance. For example, if the shutoff device 13 includes a valve 14, the valve will then be opened to enable gas to flow to the stove 11. If the shutoff device 13′ includes electrical switch 32, the circuit or switch will be closed to enable electricity to flow to the stove 11′. At this time, the cooking stove is ready for normal use by the user as indicated in step 110.

While a cooking operation is taking place, the timer 12, 12′ monitors whether the selected time period has expired in step 112. When the present timer period expires, the safety device 10, 10′ automatically places the shutoff device 13, 13′ in a “shutoff mode” (for example, closing valve 14 or opening switch 32), at step 114. With reference to step 116, if the preset timer period expires before the cooking is done, the user manually turns off the manual valves 23 or manual switch 37, proceeding back through steps 102 to 108, before restarting the cooking stove in step 110. If the cooking is done before the timer period expires, then the operation is completed. If the user is present or remembers, the user proceeds with the normal step of turning off the cooking stove. If the user realizes that the cooking will not be done before the timer period expires, the user typically has the option of extending the timer period before the timer engages the shutoff device to turn off the stove.

In an alternate embodiment, the shutoff device 13, 13′ (including valve 14 or switch 32), the timer 12, and the voltage transformer 17 can be integrated into a single device, such as a shut off valve with a programmable internal timer directly connected to a power source.

It will be understood by those skilled in the art that variations and modifications can be effected within the spirit and scope of the present invention as set forth by the appended claims. Furthermore, the equivalents of all means-or-step-plus-function elements in the claims below are intended to include any structure, material, or acts for performing the function as specifically claimed and as would be understood by persons skilled in the art of this disclosure, without suggesting that any of the structure, material, or acts are more obvious by virtue of their association with other elements.

I claim:

1. An automatic safety apparatus for controlling delivery of energy from an energy source to an appliance, the safety apparatus comprising:
a timer;
a power supply electrically connected to the timer for supplying power to the timer; and
a shutoff device electrically connected to the timer and in communication with an energy source for the appliance, said shutoff device entering a shutoff mode during which energy supplied to the appliance from the energy source is disrupted upon receiving a signal from the timer indicating expiration of a preset time entered at the timer.

2. The apparatus of claim 1, wherein the shutoff device comprises an electrically controlled gas shutoff valve and the appliance comprises a gas consuming appliance.

3. The apparatus of claim 2, wherein the appliance is a gas burning stove.

4. The apparatus of claim 2, wherein the power supply includes a voltage transformer that provides an output voltage no greater than approximately 12 volts for controlling the shutoff valve.

5. The apparatus of claim 1, wherein the timer includes an input device.

6. The apparatus of claim 5, wherein the timer is programmable and the preset time is programmed into the timer by a user.

7. The apparatus of claim 1, wherein the shutoff device comprises an electrically controlled electrical disconnect switch and the appliance comprises an electrical appliance.

8. The apparatus of claim 7, wherein the appliance is an electric stove.

9. A method of controlling operation of a cooking stove, comprising:
providing a shut off device operatively connected to an energy source for the cooking stove and a timer in communication with the shut off device;
setting the timer to a predefined time period;
turning on the cooking stove; and
when the predefined time period expires, and automatically shutting off the energy source from communication with the cooking stove to shut off energy being supplied to the cooking stove.

10. The method of claim 9, further comprising turning off a manual control for a cooking stove to shut off the cooking stove from operation before setting the timer.

11. The method of claim 10, further comprising periodically monitoring the timer during cooking to determine if the time period has expired prior to cooking being completed.
